(19) United States
(12) Patent Application Publication
(10) Pub. No.: US 2011/0194133 A1
(43) Pub. Date: Aug. 11, 2011

(54) IMAGE FORMING APPARATUS, CONTROL METHOD FOR THE SAME, AND STORAGE MEDIUM FOR PROGRAM

(75) Inventor: Minoru Fujisawa, Machida-shi (JP)

(73) Assignee: CANON KABUSHIKI KAISHA, Tokyo (JP)

(21) Appl. No.: 13/060,941

(22) PCT Filed: Nov. 17, 2010
(86) PCT No.: PCT/JP2010/070948

§ 371 Date: Feb. 25, 2011

(30) Foreign Application Priority Data
Dec. 22, 2009 (JP) 2009-291404

(51) Int. Cl. G06F 3/12

(52) U.S. Cl. 358/1.13

(57) ABSTRACT

If data is received from the information processing apparatus when the main control unit is in the second power state, it is determined, based on the received data, whether to (i) cause the main control unit to revert to the first power state or to (ii) cause the sub control unit to make a response to the received data without the main control unit reverting to the first power state. If it is determined as the case (ii), response information for the received data is generated and transmitted to the information processing apparatus, and the communication connection information held in the sub control unit is updated. If it is determined as the case (i), the main control unit is caused to revert to the first power state and notified of the communication connection information held by the sub control unit.

### TECHNICAL FIELD

The present invention relates to an image forming apparatus that performs power-saving control, a control method for the image forming apparatus, and a storage medium storing a program.

### BACKGROUND ART

As recent efforts to address environmental issues, power saving is currently being pursued in image forming apparatuses such as a printer and a multifunctional peripheral. As an example of methods to realize power saving, it is common practice to cause an image forming apparatus to transition into a power saving state after a certain period of time has elapsed without any operation on a control panel of the image forming apparatus or any print job entry via a network, thereby reducing power consumption. Japanese Patent Laid-Open No. 2006-259906 has proposed a communication control device with a power saving control function that performs operation control in a power saving state independently from operation control performed during normal operations. With this power-saving control function, an image forming apparatus notifies the communication control device of a predetermined condition prior to transition into a power saving state and then transitions into a power saving mode. Thereafter, upon receiving a packet via a network during operation in the power saving mode, the communication control device determines whether or not the image forming apparatus is to revert to a non-power saving state, depending on whether or not the received packet satisfies the predetermined condition.

With the conventional technique described above, whether or not an image forming apparatus is to revert from the power saving state to the non-power saving state is determined based on a fixed packet pattern. However, communication protocols for transmitting and receiving such packets face the fact that the amounts of information in packets are increasing, and communication sequences are complicated. Accordingly, as the structures of packets received from the network become more complicated, a problem arises in that it becomes difficult to precisely determine whether or not an image forming apparatus is to revert from the power saving state.

In addition, depending on the types of communication protocol, there are also cases in which a once established connection continues to be retained for a long period of time. When the transition from the non-power saving state to the power saving state, or the transition from the power saving state to the non-power saving state, is made while performing communication using such a communication protocol, a connection for communication cannot be retained simply by registering a fixed packet pattern. The result is that the transition into the power saving state is not possible with such a communication protocol that retains a connection in the non-power saving state. Meanwhile, many commonly used protocols, such as HTTP, FTP, and CIFS, require a connection. Accordingly, an apparatus cannot make a transition into the power saving state during operations using those protocols, thus considerably reducing the power saving efficiency.

### SUMMARY OF INVENTION

An aspect of the present invention is to eliminate the above-mentioned problems with the conventional technology.

The present invention provides a technique that allows reversion from a power saving state to be appropriately controlled in the case of using a communication protocol that requires communication connection information that is updated in accordance with execution of communication.

In order to achieve the above, the present invention in its first aspect provides an image forming apparatus an image forming apparatus comprising a main control unit that operates in at least a first power state or a second power state with lower power consumption than the first power state, and a sub control unit that performs communication with an information processing apparatus via a network when the main control unit is in the second power state, the image forming apparatus comprising: sleep control means for causing the main control unit to transition into the second power state and to notify the sub control unit of communication connection information that is updated in accordance with execution of communication via the network, so as to cause the sub control unit to hold the communication connection information; determination means for, upon reception of data from the information processing apparatus when the main control unit is in the second power state, determining, based on the received data, whether to cause the main control unit to revert to the first power state or to cause the sub control unit to make a response to the received data without the main control unit reverting to the first power state; response means for, when the determination means has determined that the sub control unit is to make a response to the received data without the main control unit reverting to the first power state, generating response information for the received data, transmitting the response information to the information processing apparatus, and updating the communication connection information held in the sub control unit; and reversion means for, when the determination means has determined to cause the main control unit to revert to the first power state, causing the main control unit to revert to the first power state and notifying the main control unit of the communication connection information held by the sub control unit.

The second aspect of the present invention provides a control method for an image forming apparatus a control method for an image forming apparatus comprising a main control unit that operates in at least a first power state or a second power state with lower power consumption than the first power state, and a sub control unit that performs communication with an information processing apparatus via a network, the control method comprising: a sleep control step of causing the main control unit to transition into the second power state and to notify the sub control unit of communication connection information that is updated in accordance with execution of communication via the network, so as to cause the sub control unit to hold the communication connection information; a determination step of, upon reception of data from the information processing apparatus when the main control unit is in the second power state, determining, based on the received data, whether to cause the main control unit to revert to the first power state or to cause the sub control unit to make a response to the received data without the main control unit reverting to the first power state; a response step of, when it has been determined in the determination step that the sub control unit is to make a response to the received data without the main control unit reverting to the first power state, generating response information for the received data, transmitting the response information to the information processing apparatus, and updating the communication connection information held in the sub control unit; and a reversion step of, when it has been determined in the determination step to cause the main control unit to revert to the first power state, causing the main control unit to revert to the first power state and notifying the main control unit of the communication connection information held in the sub control unit.

The third aspect of the present invention provides a storage medium storing a program a computer-readable storage medium storing a program to be executed by a computer comprising a main control unit that operates in at least a first power state or a second power state with lower power consumption than the first power state, and a sub control unit that performs communication with an information processing apparatus via a network, the program causing the computer to perform the steps of: causing the main control unit to transition into the second power state and to notify the sub control unit of communication connection information that is updated in accordance with execution of communication via the network, so as to cause the sub control unit to hold the communication connection information; upon reception of data from the information processing apparatus when the main control unit is in the second power state, determining, based on the received data, whether to cause the main control unit to revert to the first power state or to cause the sub control unit to make a response to the received data without the main control unit reverting to the first power state; when it has been determined in the determination step that the sub control unit is to make a response to the received data without the main control unit reverting to the first power state, generating response information for the received data, transmitting the response information to the information processing apparatus, and updating the communication connection information held in the sub control unit; and when it has been determined to cause the main control unit to revert to the first power state, causing the main control unit to revert to the first power state and notifying the main control unit of the communication connection information held by the sub control unit.

According to the present invention, it is possible to appropriately control reversion from the power saving state in the case of using a communication protocol that requires communication connection information that is updated in accordance with execution of communication.

Further features of the present invention will become apparent from the following description of exemplary embodiments with reference to the attached drawings.

### BRIEF DESCRIPTION OF DRAWINGS

FIG. 1 is a diagram showing the configuration of a network system using an image forming apparatus according to an embodiment of the present invention.

FIG. 2 is a block diagram showing the configuration of the image forming apparatus according to an embodiment of the present invention.

FIGS. 3A and 3B are diagrams illustrating the software configuration of the image forming apparatus according to an embodiment of the present invention.

FIG. 4 is a diagram showing an example of a packet format used for communication in an embodiment of the present invention.

FIG. 5 is a diagram illustrating a TCP packet format used for communication that requires a connection.

FIG. 6 is a diagram illustrating data that at a minimum needs to be transferred between a main control unit and a sub control unit in the image forming apparatus.

FIG. 7 is a flowchart illustrating processing performed by the main control unit when the image forming apparatus according to a first embodiment transitions from a non-power saving state to a power saving state.

FIGS. 8A and 8B are flowcharts illustrating processing performed by the sub control unit after the image forming apparatus according to the first embodiment has transitioned into the power saving state.

FIG. 9 is a diagram showing an overview of a communication packet format used in a SMB/CIFS protocol.

FIG. 10 is a diagram showing an example of the most typical normal sequence performed between a client and a server.

FIG. 11 is a flowchart illustrating processing performed by the sub control unit in the power saving state according to a second embodiment.

### DESCRIPTION OF EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. The same reference numerals have been given to constituent elements that are the same, and redundant descriptions thereof will not be given.

### First Embodiment

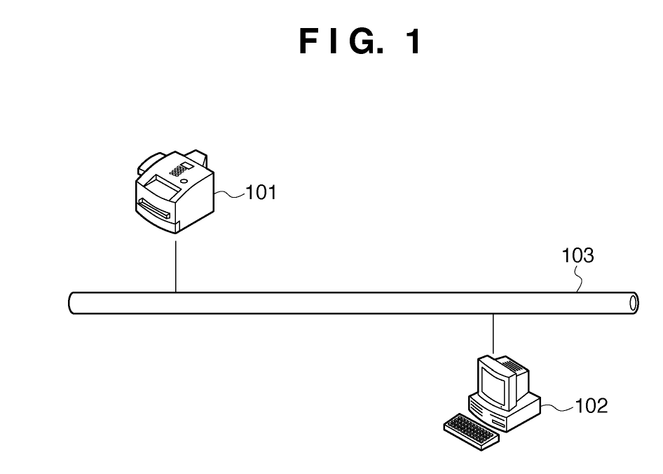

FIG. 1 is a diagram showing the configuration of a network system using an image forming apparatus 101 according to an embodiment of the present invention.

In this network system, the image forming apparatus 101, such as a printer, and an information processing apparatus (PC) 102, such as a personal computer, are connected via a network 103 and are capable of communicating with each other.

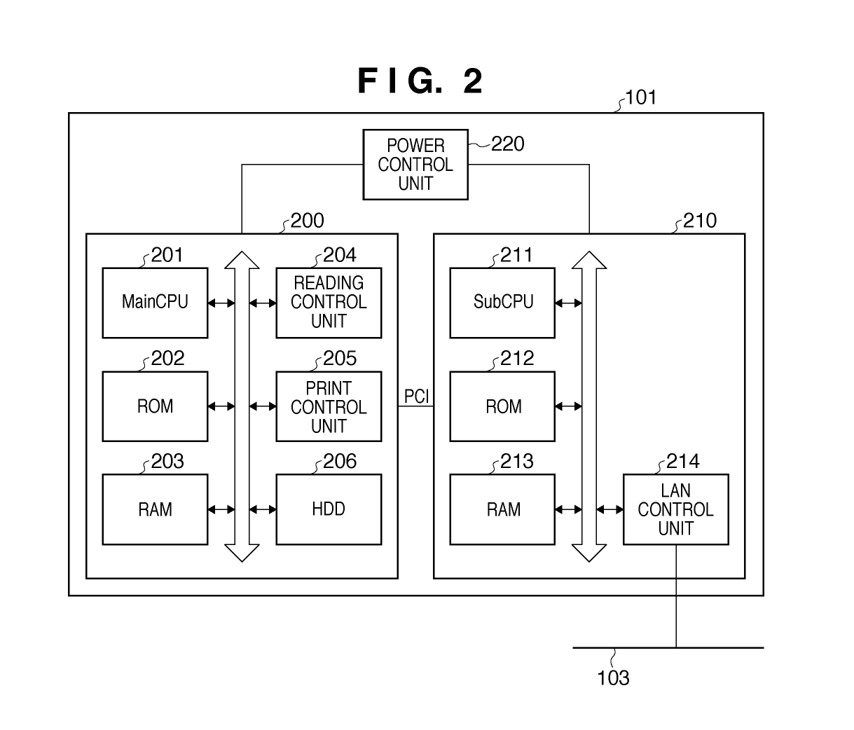

FIG. 2 is a block diagram showing the configuration of the image forming apparatus 101 according to the present embodiment.

The image forming apparatus 101 includes a main control unit 200 controlled by a Main CPU 201 and a sub control unit 210 controlled by a Sub CPU 211, and the main control unit 200 and the sub control unit 210 are connected via a PCI bus. The main control unit 200 controls a reading control unit 204 and a print control unit 205 and achieves image forming processing functions such as copying and printing that are well-known for an image forming apparatus. Programs for controlling such functions and a power saving control function are stored in a ROM 202 or an HDD 206, and those programs are loaded into a RAM 203 at the time of startup of the image forming apparatus 101 and executed by the Main CPU 201. The sub control unit 210 transmits and receives packets via a LAN control unit 214 and the network 103 and achieves functions that at a minimum are necessary for controlling reversion to a non-power saving state after the image forming apparatus 101 has transitioned into a power saving state. Programs for controlling such functions of the sub control unit 210 are stored in a ROM 212, and those programs are loaded into a RAM 213 at the time of startup of the image forming apparatus 101 and executed by the Sub CPU 211. When the image forming apparatus 101 transitions from the non-power saving state to the power saving state, information used as a condition for subsequent reversion from the power saving state to the non-power saving state is transmitted from the main control unit 200 to the sub control unit 210 and stored in the RAM 213. A power control unit 220 controls power supply to each block in the image forming apparatus 101, and in particular it is capable of reducing power consumption of the overall image forming apparatus 101 by stopping the power supply to the main control unit 200 and thereby causing the image forming apparatus to transition into the power saving state.

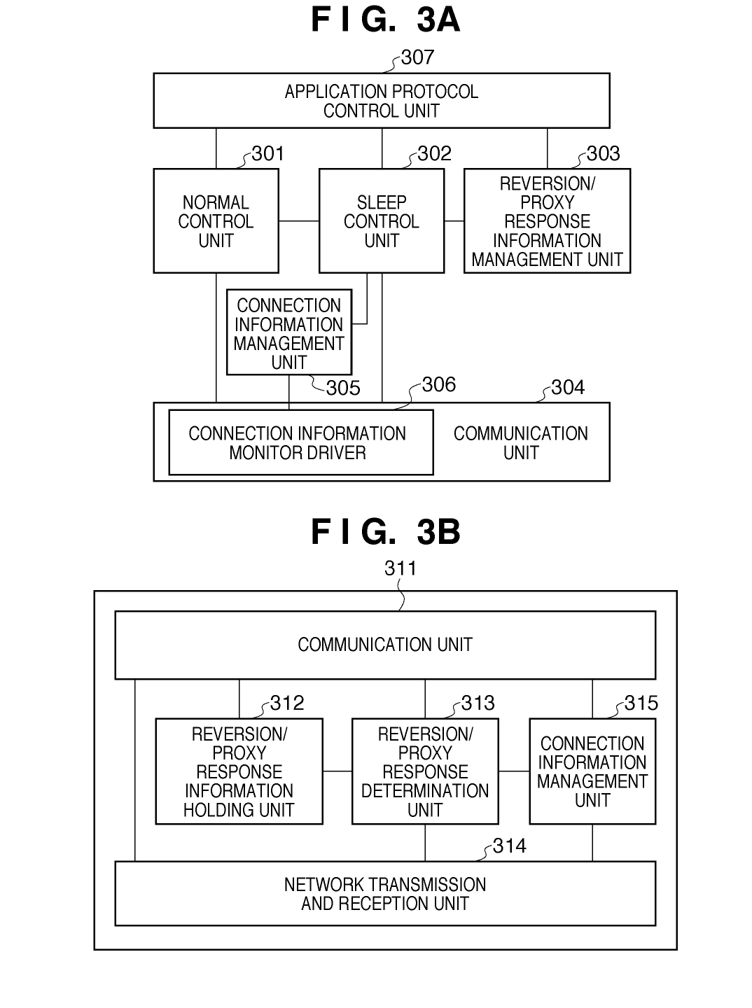

FIGS. 3A and 3B are diagrams illustrating the software configuration of the image forming apparatus 101 according to the present embodiment, FIG. 3A showing the software configuration of the main control unit 200 and FIG. 3B showing the software configuration of the sub control unit 210. Note that constituent elements in these drawings indicate software blocks (modules) having different software functions, and those blocks are executed in parallel by their corresponding CPUs.

Referring to FIG. 3A, a normal control unit 301 controls various operations of the image forming apparatus 101 during normal operations in the non-power saving state. A reversion/proxy response information management unit 303 holds information indicating a condition for reversion from the power saving state to the non-power saving state and a condition for giving a proxy response while retaining the power saving state. A sleep control unit 302 acquires the condition information held by the reversion/proxy response information management unit 303 and connection management information (communication connection information) held by a connection information management unit 305, and transmits the condition information and the connection management information to a communication unit 304. Thereafter, the sleep control unit 302 instructs the power control unit 220 to transition into the power saving state. The communication unit 304 performs communication with a communication unit 311 in the sub control unit 210 so as to allow information to be exchanged with the sub control unit 210. A connection information monitor driver 306 monitors a communication packet received by the sub control unit 210 through a network transmission and reception unit 314, acquires connection management information described later, and stores the connection management information in the connection information management unit 305. The connection information management unit 305 receives connection information for each individual communication connection from the connection information monitor driver 306 and holds the connection information.

An application protocol control unit 307 operates in the non-power saving state. When the image forming apparatus 101 receives various packets from a client, the application protocol control unit 307 acquires data for each application through the normal control unit 301. Also, the application protocol control unit 307 receives a notification of transition from the non-power saving state to the power saving state through the sleep control unit 302. This allows the application protocol control unit 307 to recognize that the image forming apparatus is to transition from the non-power saving state to the power saving state. After the image forming apparatus has transitioned into the power saving state, the application protocol control unit 307 further sets a condition for reversion from the power saving state to the non-power saving state or a condition for giving a proxy response in the reversion/proxy response information management unit 303.

Referring next to FIG. 3B, the communication unit 311 performs communication with the communication unit 304 in the main control unit 200 and exchanges information with the main control unit 200. A reversion/proxy response information holding unit 312 receives and holds reversion/proxy response condition information held by the reversion/proxy response information management unit 303 through the communication unit 311. A connection information management unit 315 receives and holds the connection management information held by the connection information management unit 305 through the communication unit 311. A reversion/proxy response determination unit 313 analyzes a packet received from the network transmission and reception unit 314. Then, the reversion/proxy response determination unit 313 determines whether to cause the image forming apparatus to revert to the non-power saving state or to give a proxy response in the power saving state or not to perform any processing, using the information held by the reversion/proxy response information holding unit 312 and the information held by the connection information management unit 315. Note that, in the non-power saving state, a packet received by the network transmission and reception unit 314 is passed as is through the communication unit 311 to the main control unit 200. On the other hand, in the power saving state, a packet received by the network transmission and reception unit 314 is passed to the reversion/proxy response determination unit 313.

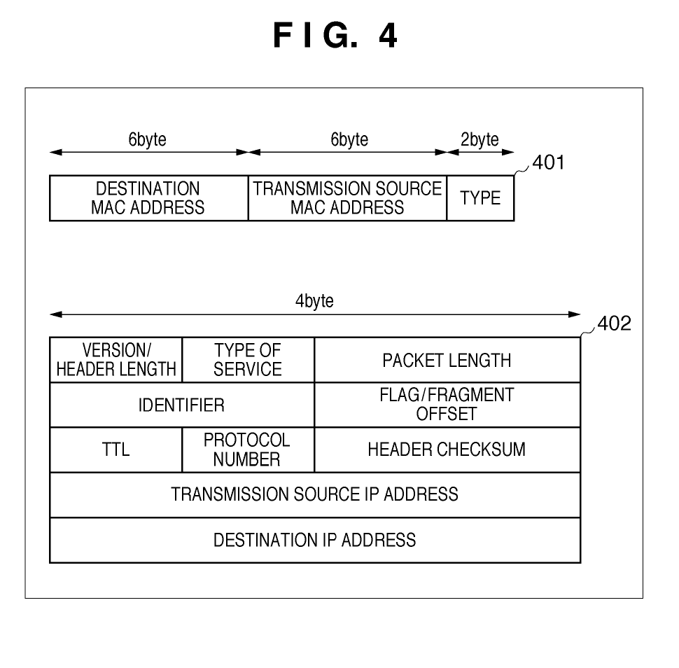

FIG. 4 is a diagram showing an example of a packet format used for communication in the present embodiment.

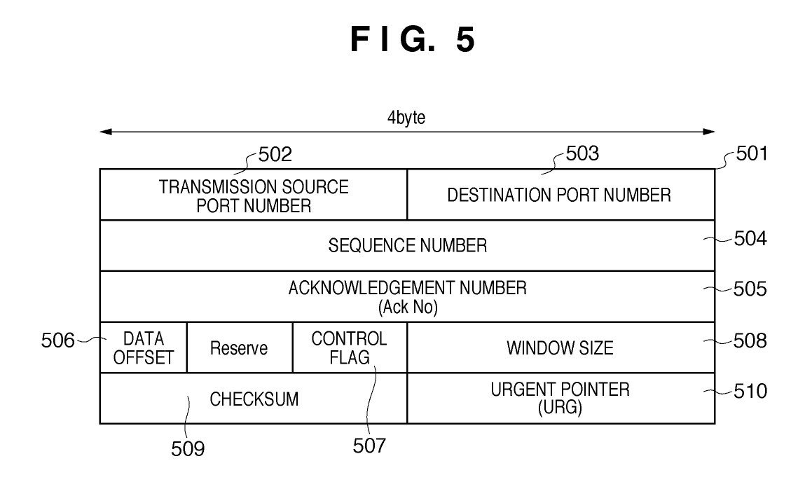

A communication packet includes an Ether header 401 and a subsequent IP header 402. An example of packets requiring a connection includes a TCP (transmission control protocol) packet. The TCP packet has a structure in which the Ether header 401 and the IP header 402 are followed by a TCP packet header. Note that, although a description of the TCP packet is given later with reference to FIG. 5, specifications of the TCP are defined by the RFC 793.

FIG. 5 is a diagram illustrating a TCP packet format used for communication that requires a connection.

In general, a TCP header 501 is present in communication that requires a connection. Connection management is performed using information included in the TCP header 501. Connection management as used herein refers to control that is performed to ensure communication reliability, such as sequence control for communication packets transmitted and received during connection, retransmission control performed at the time of a packet loss, packet transmission rate control, and congestion avoidance control. A transmission source port number 502 is 2 bytes and indicates a port number on the transmission side of the communication packet. A destination port number 503 is 2 bytes and indicates a port number on the reception side of the communication packet. In the case of communication requiring a connection, the transmission source port number 502 and the destination port number 503 are fixed values unless the connection is closed or changed. A sequence number 504 is 4 bytes and indicates the position of data in the transmitted packet, and a value equal to the size of transmission data is added to the sequence number 504 every time data is transmitted.

An acknowledgement number (Ack No) 505 is 4 bytes and indicates a sequence number of data to be subsequently received. Accordingly, when the sequence number 504 of a packet to be subsequently transmitted from the transmission side and the acknowledgement number 505 of a received packet are the same, it indicates that communication has been thus far performed normally. A data offset 506 is 4 bits and indicates the starting position of a data part field in the TCP packet. A control flag 507 is 6 bits and indicates control information regarding the TCP packet. Flag types URG, ACK, PSH, RST, SYN, and FIN are set in the individual bits of the control flag 507, respectively. URG indicates that urgent data is included. ACK indicates that the value of the acknowledgement number 505 is valid. PSH indicates that received data needs to be passed to an upper-level application protocol. RST indicates that the connection has been forcefully disconnected for any reason. SYN indicates a request to establish connection. FIN indicates a request to disconnect the connection because there is no data to be transmitted thereafter. In the case of communication requiring a connection, connection management is performed by controlling the control flag 507 for each communication sequence.

A window size 508 is 2 bytes and indicates the size of data that can subsequently be received at a position starting from the data position indicated by the acknowledgement number 505. The transmission side cannot transmit an amount of data over the value of the window size 508. The value of the window size 508 will be changed dynamically for each communication sequence, depending on the state of a packet to be processed on the reception side, the size of a reception buffer prepared on the reception side, settings of a protocol stack on the reception side, and so on. A checksum 509 is 2 bytes and provides reliability of the header part and the data part in the TCP packet. The transmission side calculates the checksum 509 for each individual packet and adds a calculated result to the packet. The reception side is capable of checking whether or not packet corruption has occurred on a communication path by checking the checksum in the received packet. An urgent pointer (URG) 510 is 2 bytes and indicates a pointer to the position where data of urgency is to be stored. Operations to be performed upon receiving urgent data are determined by individual applications on the reception side. As seen from the individual contents in the TCP packet described above, a field having a value that is dynamically changed for each communication sequence is present in the case of performing communication requiring a connection. Accordingly, it is difficult, by using only the packet pattern information of a fixed length, to determine whether or not the image forming apparatus is to revert from the power saving state to the non-power saving state.

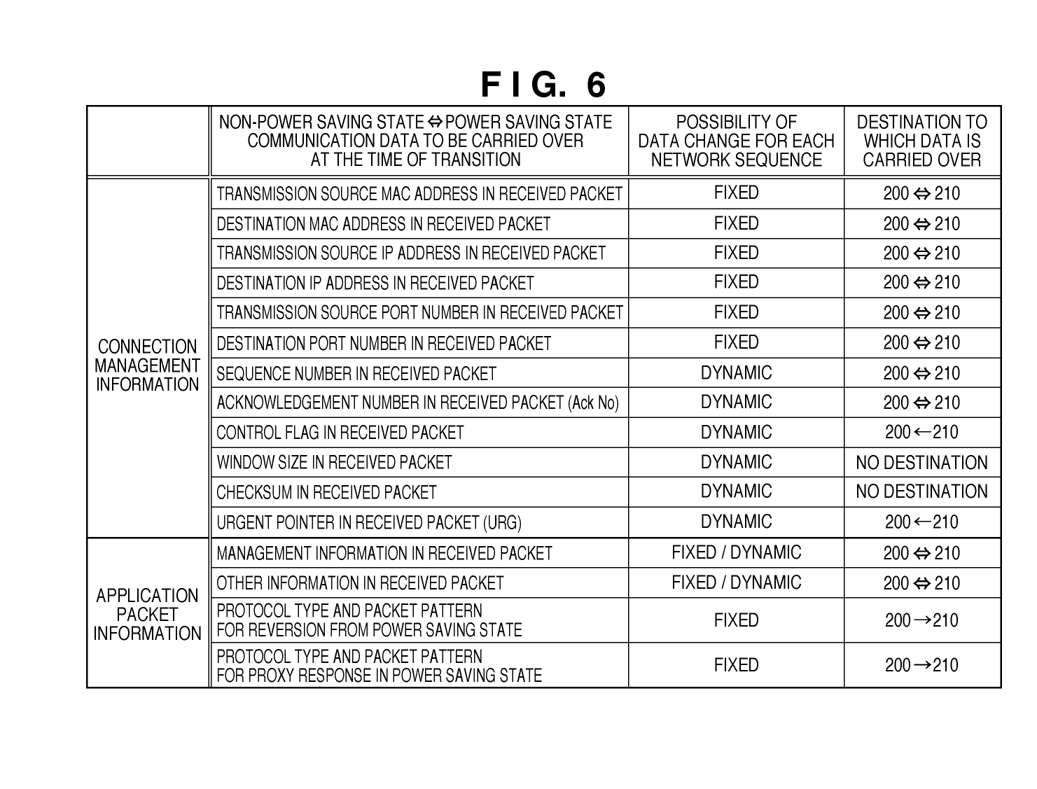

FIG. 6 is a diagram illustrating data that at a minimum needs to be transferred between the main control unit 200 and the sub control unit 210 in the image forming apparatus 101 according to the present embodiment. Note that, in this drawing, 200 indicates the main control unit and 210 indicates the sub control unit.

This drawing shows a list of data that at a minimum needs to be carried over from the main control unit 200 to the sub control unit 210 when the image forming apparatus transitions into the power saving state from a situation where connection is retained in the non-power saving state. FIG. 6 also shows a list of data that at a minimum needs to be carried over from the sub control unit 210 to the main control unit 200 when the image forming apparatus transitions into the non-power saving state from a situation where connection is retained in the power saving state. FIG. 6 also indicates whether or not there is a possibility that data that at a minimum needs to be carried over may be changed during a communication sequence performed while retaining a connection between the transmission side and the reception side. FIG. 6 further shows whether or not data held for each individual connection needs to be carried over to the main control unit 200 or the sub control unit 210 at the time of transition into either state.

In the case of performing communication such as UDP communication that does not require a connection, upon receiving a packet in the non-power saving state, the main control unit 200 acquires and holds transmission source and destination MAC addresses, transmission source and destination IP addresses, and application packet information from the received packet. Thereafter, when transitioning from the non-power saving state to the power saving state, the main control unit 200 carries over the acquired information to the sub control unit 210 and transitions into the power saving state. Meanwhile, upon receiving a packet in the power saving state, the sub control unit 210 checks the received packet based on the transmission source and destination MAC addresses, the transmission source and destination IP addresses, and packet pattern information transmitted from the main control unit 200. Based on a result of the check, the sub control unit 210 determines whether to cause the image forming apparatus to revert from the power saving state to the non-power saving state or to generate a response packet and give a proxy response instead of the main control unit 200 or to ignore the received packet. As result of the determination, if it has been determined that a proxy response is to be given or the received packet is to be ignored, the sub control unit 210 continues to operate in the power saving state. On the other hand, if it has been determined that the image forming apparatus is to revert from the power saving state to the non-power saving state, the sub control unit 210 carries over the transmission source and destination MAC addresses, the transmission source and destination IP addresses, and the application packet information in the received packet to the main control unit 200, and thereafter the image forming apparatus transitions into the non-power saving state.

In the case of performing communication such as TCP communication that requires a connection, when a packet is received in the non-power saving state, the main control unit 200 cannot manage and retain a connection simply by using packet information that would be acquired and managed at the time of communication that does not require a connection. In order to manage and retain a connection, the main control unit needs to acquire and manage at least connection management information shown in FIG. 6. When transition into the power saving state occurs while retaining a connection, the main control unit 200 carries over at least all connection management information other than the control flag, the window size, the checksum, and the urgent pointer, and the application packet information to the sub control unit 210. Then, when receiving a packet in the power saving state, the sub control unit 210 checks the received packet based on the information carried over from the main control unit 200. Based on a result of the check, the sub control unit 210 determines whether to cause the image forming apparatus to revert from the power saving state to the non-power saving state or to generate a response packet and give a proxy response instead of the main control unit 200 or to ignore the received packet.

If the received packet has been determined to be ignored, the sub control unit 210 continues to operate in the power saving state. Or if it has been determined that the sub control unit 210 is to give a proxy response instead of the main control unit 200, the sub control unit 210 newly generates or updates data of FIG. 6 that is changed dynamically, with use of the received packet and the information passed from the main control unit 200. The sub control unit 210 generates a response packet with use of the data that is changed dynamically and the remaining fixed data and transmits the response packet to the transmission source. If it has been determined that the image forming apparatus is to revert from the power saving state to the non-power saving state, the sub control unit 210 acquires the connection management information and the application packet information shown in FIG. 6 from the received packet. The sub control unit 210 then carries over, among those pieces of information, at least all connection management information other than the window size and the checksum and the application packet information to the main control unit 200, and thereafter the image forming apparatus transitions into the non-power saving state. After the reversion to the non-power saving state, the main control unit 200 continues processing for a subsequent sequence while retaining the connection, with use of the connection management information carried over from the sub control unit 210. Note that the process of transition from the non-power saving state to the power saving state and the process of transition from the power saving state to the non-power saving state will be described later.

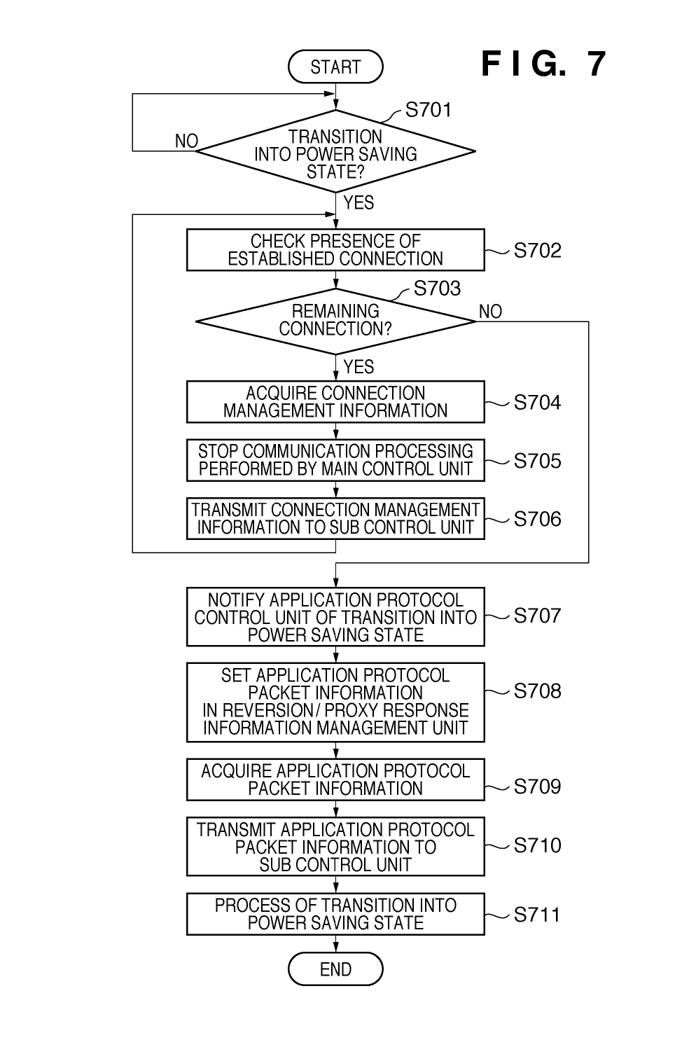

FIG. 7 is a flowchart illustrating processing performed by the main control unit 200 when the image forming apparatus 101 according to the first embodiment transitions from the non-power saving state to the power saving state. This processing is performed under control of the Main CPU 201 in accordance with a program loaded into the RAM 203.

First, the sleep control unit 302 determines in step S701 whether or not the main control unit 200 is to transition into the power saving state. The determination of whether or not to transition into the power saving state is made depending on whether or not an instruction to transition into a sleep mode is issued manually by a user who uses the image forming apparatus 101. Alternatively, the determination may be made by the sleep control unit 302 monitoring and determining whether or not the image forming apparatus 101 has been left inactive for a certain period of time. If the main control unit has been determined not to transition into the power saving state in step S701, the sleep control unit 302 either makes a determination again after a certain period of time or is brought into a standby state until reception of an instruction to transition into a sleep mode from a user. If the main control unit has been determined to transition into the power saving state, then the procedure proceeds to step S702, in which the sleep control unit 302 checks whether or not a currently established connection is present, with the help of the connection information management unit 305. If it has been determined in step S703 that an established connection is present, then the procedure proceeds to step S704. In step S704, the sleep control unit 302 acquires the connection management information from the connection information management unit 305 and passes the connection management information to the communication unit 304. The procedure then proceeds to step S705, in which the sleep control unit 302 deletes the connection management information that has been passed to the communication unit 304 in step S704, from the connection information management unit 305 and stops targeted connection communication that is being performed on the main control unit 200 side. The procedure then proceeds to step S706, in which the communication unit 304 transmits the connection management information to the communication unit 311 in the sub control unit 210. The communication unit 311 thereby passes the connection management information received from the communication unit 304 in the main control unit 200 to the connection information management unit 315, and thereafter the procedure returns to step S702. In this way, it is determined in step S703 whether or not checks of all connections have been ended, and if the checks of all connections have not yet been ended, the procedure proceeds to step S704 in which the processing as described above is performed, whereas if the checks of all connections have been ended, the procedure proceeds to step S707.

In step S707, the sleep control unit 302 in the main control unit 200 notifies the application protocol control unit 307 that transition into the power saving state is to be made. This notification of transition into the power saving state is provided by way of a notification to a call-back function prepared on the application protocol control unit 307 side, processing for transmitting a message from the sleep control unit 302 to the application protocol control unit 307, and so on. This allows the application protocol control unit 307 to recognize that the image forming apparatus is to transition from the non-power saving state to the power saving state. The procedure then proceeds to step S708, in which, upon receiving a notification of transition into the power saving state, the application protocol control unit 307 sets a condition for reversion to the non-power saving state after the image forming apparatus has transitioned into the power saving state or a condition for giving a proxy response in the reversion/proxy response information management unit 303. Then, the procedure proceeds to step S709, in which the sleep control unit 302 acquires, for each application protocol, pattern packet information for power reversion or proxy response from the reversion/proxy response information management unit 303. The sleep control unit 302 passes the acquired pattern packet information to the communication unit 304. Then, the communication unit 304 transmits the pattern packet information to the communication unit 311 in the sub control unit 210 in step S710. The communication unit 311 thereby transmits the pattern packet information received from the communication unit 304 to the reversion/proxy response information holding unit 312. The procedure then proceeds to step S711, in which the sleep control unit 302 in the main control unit 200 instructs the power control unit 220 to transition into the power saving state. Accordingly, subsequent connection management and per-application communication management are shifted from the main control unit 200 to the sub control unit 210, and thereby the transition into the power saving state is achieved.

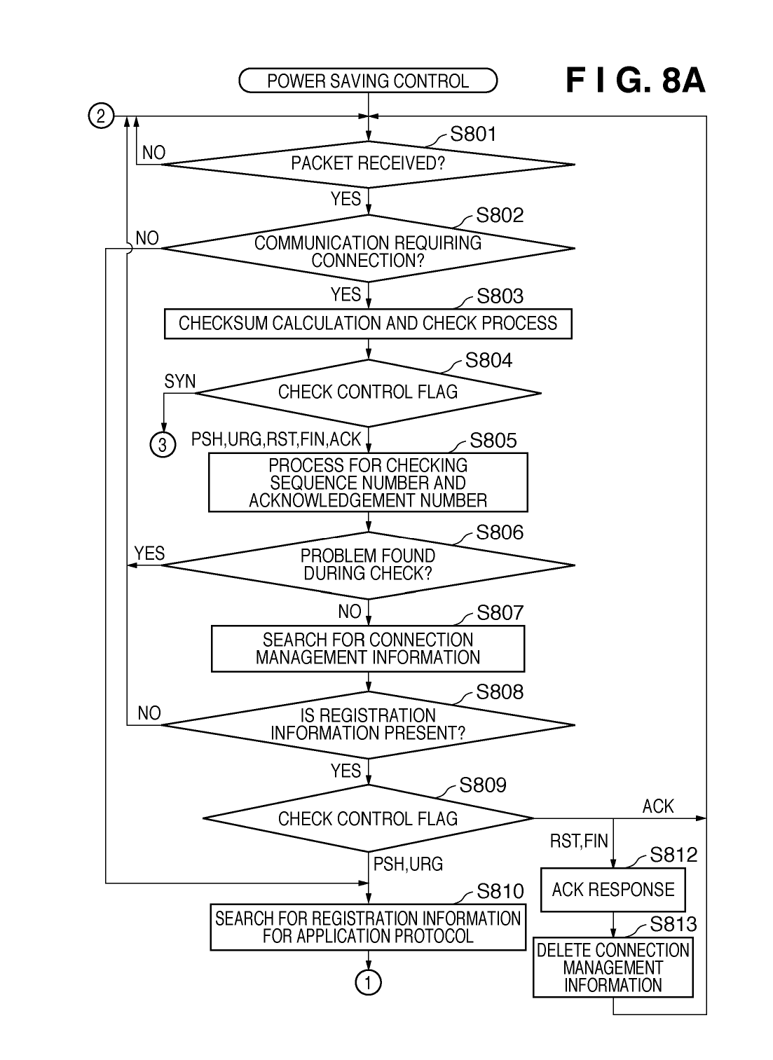

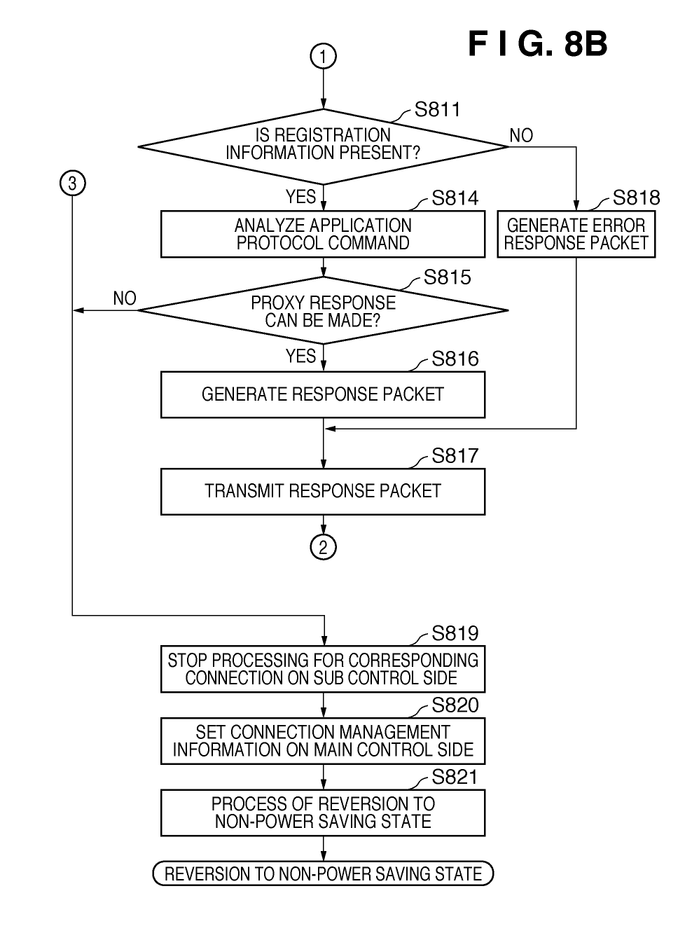

FIGS. 8A and 8B are flowcharts illustrating processing performed by the sub control unit 210 after the image forming apparatus 101 according to the first embodiment has transitioned into the power saving state. This processing is performed under control of the Sub CPU 211 in accordance with a program stored in the ROM 212.

First, the network transmission and reception unit 314 determines in step S801 whether or not a packet has been received from another party via the network 103. When a packet has been received, the procedure proceeds to step S802, in which the network transmission and reception unit 314 determines whether or not the communication is accompanied with connection, based on the transmission source and destination MAC addresses, the transmission source and destination IP addresses, and the transmission source and destination port numbers in the received packet. If the communication has been determined not to be accompanied with connection, the procedure proceeds to step S810 to perform processing. On the other hand, if the communication has been determined to be accompanied with connection, then the procedure proceeds to step S803, in which the network transmission and reception unit 314 calculates a checksum and determines whether or not packet corruption has occurred on a communication path. The procedure then proceeds to step S804, in which the network transmission and reception unit 314 checks the control flag in the packet received in step S801. If the control flag indicates any type other than SYN, the procedure proceeds to step S805. In step S805, the network transmission and reception unit 314 acquires the sequence number 504 and the acknowledgement number 505 (FIG. 5) in the received packet. The network transmission and reception unit 314 also acquires the sequence number 504 and the acknowledgement number 505 from the connection information management unit 315. Then, the network transmission and reception unit 314 determines whether or not the sequence numbers 504 and the acknowledgement numbers 505 acquired from the received packet and the connection information management unit match with each other (step S806). If the numbers do not match in step S806, it is determined that a problem has been detected, and the network transmission and reception unit 314 discards the received packet, and thereafter the procedure returns to step S801.

If the numbers match in step S806, the procedure proceeds to step S807, in which the network transmission and reception unit 314 searches for targeted connection management information stored in the connection information management unit 315. Then in step S808, if targeted connection has not been registered in the connection information management unit 315, the network transmission and reception unit 314 discards the received packet and thereafter the procedure returns to step S801. On the other hand, if the targeted connection has been registered, the network transmission and reception unit 314 acquires the targeted connection management information from the connection information management unit 315. The procedure then proceeds to step S809, in which the network transmission and reception unit 314 checks the control flag in the received packet and confirms a packet control method.

If the control flag is Ack, the network transmission and reception unit 314 transmits the connection management information included in the received packet to the connection information management unit 315, and thereafter the procedure returns to step S801. If the control flag is either RST or FIN, the procedure proceeds to step S812, in which the network transmission and reception unit 314 generates an Ack response packet for the received packet and transmits the Ack response packet to the other party via the network 103. Then, in step S813, the network transmission and reception unit 314 deletes the targeted connection management information stored in the connection information management unit 315, and thereafter the procedure returns to step S801. This means that the targeted connection has been disconnected. If the control flag is either PSH or URG in step S809, the procedure proceeds to step S810, in which the network transmission and reception unit 314 passes the received packet to the reversion/proxy response determination unit 313. The reversion/proxy response determination unit 313 thereby searches for an application protocol for which it is necessary to make a reversion or give a proxy response, based on the destination port number 503 in the received packet and the port number stored in the reversion/proxy response information holding unit 312. The procedure then proceeds to step S811, in which it is determined whether or not the search was successfully made and accordingly it is possible to make a reversion or give a proxy response for the received packet. If a reversion is to be made or a proxy response is to be given, the procedure proceeds to step S814, in which the reversion/proxy response determination unit 313 analyzes a command for each application protocol that corresponds to the destination port number 503 in the received packet and determines whether or not a proxy response is to be given (step S815). If it has been determined in step S815 that a proxy response is to be given, the procedure proceeds to step S816, in which the reversion/proxy response determination unit 313 generates a response packet for the received packet. The procedure then proceeds to step S817, in which the reversion/proxy response determination unit 313 transmits the proxy response packet to the network 103 through the network transmission and reception unit 314. On the other hand, if the received packet does not correspond to the case of making a reversion or giving a proxy response in step S811, the procedure proceeds to step S818, in which the reversion/proxy response determination unit 313 generates an error response packet for the received packet and transmits the error response packet in step S817. In step S818, although there are cases in which an error response packet is generated and transmitted, as an alternative to this, there is also a processing method as a means for discarding the received packet and returning to step S801 without transmitting a response packet.

If it has been determined in step S815 that a proxy response is not to be given, the procedure proceeds to step S819, in which the reversion/proxy response determination unit 313 instructs the network transmission and reception unit 314 and the connection information management unit 315 to stop connection control processing. Also, if the control flag is Syn in the above-described step S804, the procedure also proceeds to step S819, in which the reversion/proxy response determination unit 313 instructs the network transmission and reception unit 314 and the connection information management unit 315 to stop connection control processing.

The procedure then proceeds to step S820, in which the reversion/proxy response determination unit 313 passes all the connection management information from the communication unit 311 in the sub control unit 210 through the communication unit 304 in the main control unit 200 to the connection information management unit 305 in the main control unit 200. The procedure then proceeds to step S821, in which the reversion/proxy response determination unit 313 instructs the sleep control unit 302 in the main control unit 200 to revert from the power saving state through the communication unit 311 and the communication unit 304.

According to the first embodiment as described above, there is an effect in that the image forming apparatus can transition from the non-power saving state to the power saving state while retaining a connection in the power saving state.

There is also another effect in that, even if the packet structure gets complicated, the image forming apparatus can transition from the power saving state to the non-power saving state.

### Second Embodiment

The following describes a second embodiment in the case of using an SMB/CIFS protocol as an example of communication protocols using connection, with reference to the drawings. Note that the configuration of an image forming apparatus 101 and the configuration of a network system according to the second embodiment are similar to those in the first embodiment described above, and therefore descriptions thereof will not be given.

An SMB (Server Message Block) protocol is a remote file exchange protocol provided by Microsoft Corporation and used quite commonly on Windows. The details of specifications thereof have been defined in the following URL: http://msdn.microsoft.com/jajp/library/cc246231 (en-us,PROT.10).aspx.

Like the SMB protocol, a CIFS (Common Internet File System) protocol is also a remote file exchange protocol similar to the SMB protocol. The details of specifications thereof have been defined in the following URL: http://www.monyo.com/technical/samba/translation.

According to their specifications, the SMB/CIFS protocols use either packets that operate on the TCP protocol or packets that operate on the UDP protocol, depending on processing contents. Here, a description is given taking, as an example, processing using the TOP protocol related to the present embodiment.

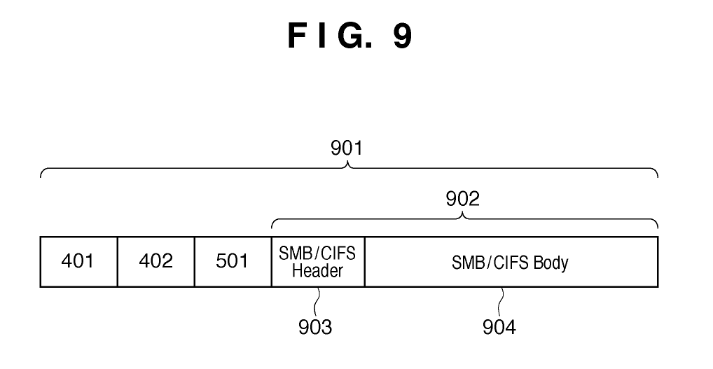

FIG. 9 is a diagram showing an overview of a communication packet format used in the SMB/CIFS protocol.

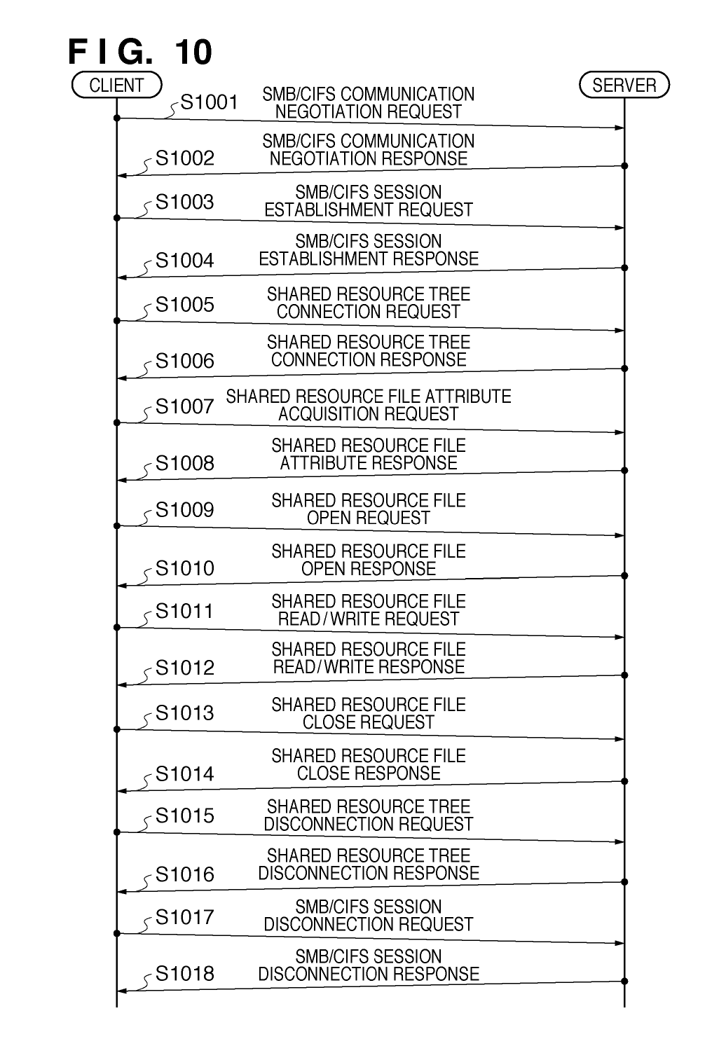

Reference numeral 901 designates the overall structure of an SMB/CIFS packet. The SMB/CIFS packet 901 includes an Ether header 401 and a subsequent IP header 402. The SMB/CIFS packet 901 also includes a TCP header 501 that follows the IP header 402 and requires a connection. In the case of performing file exchange processing, the SMB/CIFS packet 901 always includes the Ether header 401, the IP header 402, and the TOP header 501. Reference numeral 902 designates an SMB/CIFS protocol field. The SMB/CIFS protocol field 902 is roughly divided into two parts, namely an SMB/CIFS header 903 and an SMB/CIFS main body 904. The SMB/CIFS header 903 defines the types of requests from a client, a response code returned from a server, IDs used in various types of processing, and an option flag. The SMB/CIFS main body 904 defines detailed information regarding the types of requests defined by the SMB/CIFS header 903 and requests themselves. With reference to FIG. 10 and subsequent drawings, procedures performed for the individual types of requests in packets and the details of packets related to those procedures will be described.

FIG. 10 is a diagram showing an example of the most typical normal sequence performed between a client and a server in the case of browsing a remote file between terminals or performing file exchange.

In step S1001, in order to perform communication using an SMB/CIFS protocol, the client notifies the server of version information for the SMB/CIFS protocol supported by the client and issues a negotiation request to the server. In step S1002, the server receives the negotiation request from the client and acquires the protocol version information. The server then compares the protocol version information with its own supported protocol information and returns a response to the client in order to negotiate about the supported protocol version between the client and the server. Here, if the client and the server support the same protocol version, the negotiation is successfully ended.

Then, in step S1003, the client issues a request to establish an SMB/CIFS protocol session to the server. In this session establishment processing, processing for authorizing the client and so on are usually performed. Then, if the session establishment processing has successfully been performed, the server assigns a specific user ID to the client, sets the user ID in a session establishment response, and notifies the client of the session establishment response in step S1004. In subsequent processing in step S1005 and later steps, the server identifies the client based on the user ID. In step S1005, the client issues a request to connect to a shared resource tree including path information for a shared resource to the server, in order to access the shared resource such as a file to be browsed, to be read, or to be written to. Then, in step S1006, the server acquires the path information for the shared resource and the user ID from the received shared resource tree connection request and assigns a tree ID that allows the client given the user ID to access the path information. Then, the server sets the tree ID in a shared resource tree connection response and notifies the client of the shared resource tree connection response. This allows the client to access (e.g., browse, read, or write to) a specific shared resource in the server. Through processing performed in step S1007 and subsequent steps, the server specifies the path information for the shared resource to be accessed by the client, using the tree ID.

In step S1007, the client issues a request to acquire the attribute of the shared resource to the server, in order to acquire a file under the specific shared folder to be accessed and attribute information for the shared file. In step S1008, the server receives the shared resource attribute acquisition request, acquires and sets attribute information for the corresponding shared resource in a shared resource attribute response, and notifies the client of the shared resource attribute response. If the client wants to access (e.g., read or write to) a specific file, the client issues a request to open a specific path to be accessed to the server in step S1009. In step S1010, the server thereby acquires resource path information to be processed by the client from the received open request and determines whether or not a corresponding path is present. Depending on a determination result of the presence or absence of the resource path, the server opens the resource path or generates a new resource path. If the open processing has successfully been performed, the server assigns a file ID to the corresponding file. Then, the server sets a result of the open processing and the file ID in an open processing response and notifies the client of the open processing response. This allows the client to access the shared resource.

The procedure then proceeds to step S1011, in which, after the open processing has successfully been performed, the client issues a read or write request to the server, using the file ID. Then, in step S1012, the server acquires the file ID from the received read or write request and specifies a file targeted for processing. The server then performs processing requested by the client on the targeted file. A result of the processing performed on the file is then set in a read or write response and the client is notified of the read or write response.

In step S1013, if the access to a specific file is to be ended, the client issues a request to close a resource to the server, using the file ID assigned to the specific file. In step S1014, the server thereby acquires the file ID from the received resource close request and specifies the file corresponding to the file ID. The server then closes the file corresponding to the file ID and deletes the file ID assigned to that file. Then, the server sets the file ID and a result of the close processing in a resource close response, and notifies the client of the resource close response. This completes the client's operation of browsing the shared resource.

However, the connection to the shared resource tree is still retained between the client and the server at the point in time when step S1014 has been ended. Accordingly, the assigned user ID and the assigned tree ID remain unchanged as well, so that the client given the user ID can browse the shared resource simply by performing the processing in steps S1007 and S1008 again on the server, using the path to the shared resource tree corresponding to the tree ID. The client given the user ID can also access a specific file simply by performing the processing in steps S1007 to S1014 or the processing in steps S1009 to S1014 again on the server, using the tree ID.

In the case of disconnecting the shared resource tree, in step S1015, the client issues a request to disconnect a shared resource tree to the server, using the tree ID. In step S1016, the server acquires the tree ID from the received shared resource tree disconnection request and specifies a shared resource tree corresponding to the tree ID. The server then deletes information regarding the corresponding shared resource tree and the tree ID, sets the results thereof and the tree ID in a shared resource tree disconnection response, and notifies the client of the shared resource tree disconnection response. This ends the client's access to the specific shared resource. However, the SMB/CIFS session is still retained between the client and the server at the point in time when step S1016 has been ended. Accordingly, the assigned user ID remains unchanged, and therefore the client can access the shared resource tree or other shared resource trees in the server simply by performing the processing in steps S1005 and S1006 again, using the user ID. In the case of disconnecting the SMB/CIFS session, in step S1017, the client issues a request to disconnect an SMB/CIFS session to the server, using the user ID. In step S1018, the server thereby acquires the user ID from the received SMB/CIFS session disconnection request and specifies an SMB/CIFS session corresponding to the user ID. The server then deletes information regarding the SMB/CIFS session and the user ID, sets the results thereof and the user ID in an SMB/CIFS session disconnection response, and notifies the client of the SMB/CIFS session disconnection response.

According to the second embodiment, in the non-power saving state, the application protocol control unit 307 in the main control unit 200 receives SMB/CIFS data from the client and gives a response. Through this, management data such as the user ID, the tree ID, the file ID, and the option flag is held. In other words, according to the second embodiment, the application protocol control unit 307 serves as an SMB/CIFS protocol control unit that controls the procedure shown in FIG. 10. Although a plurality of application protocol control units 307 exist for individual network protocols, a description of the SMB/CIFS protocol control unit is given in the second embodiment.

Referring as an example to FIG. 10, the SMB/CIFS protocol control unit receives requests described in steps S1001, S1003, S1005, S1007, S1009, S1011, S1013, S1015, and S1017 from packets sent from the client in the non-power saving state. The SMB/CIFS protocol control unit also notifies the client of responses to those requests in steps S1002, S1004, S1006, S1008, S1010, S1012, S1014, S1016, and S1018. During these processes, the SMB/CIFS protocol control unit holds management data such as the user ID, the tree ID, the file ID, and the option flag and manages SMB/CIFS sessions, trees, and resources. Processing of SMB/CIFS application transition performed when the image forming apparatus 101 transitions from the non-power saving state to the power saving state can be applied to the processing in steps S707 and S708 in the flowchart of FIG. 7. Specifically, the sleep control unit 302 notifies the SMB/CIFS protocol control unit to transition into the power saving state in step S707. This allows the SMB/CIFS protocol control unit to recognize that an instruction to transition from the non-power saving state to the power saving state has been issued. The procedure then proceeds to step S708, in which the SMB/CIFS protocol control unit that has received a notification of transition into the power saving state sets a condition for reversion to the non-power saving state after the transition into the power saving state has been made or a condition for giving a proxy response in the reversion/proxy response information management unit 303 in the main control unit 200. At this time, the SMB/CIFS protocol control unit sets its own managing information, such as the user ID, the tree ID, the file ID, and the option flag, the other party's IP address, and a protocol type (SMB/CIFS in the second embodiment) in the reversion/proxy response information management unit 303. The SMB/CIFS protocol control unit further sets path and attribute information for all resources, for which a client having a specific user ID and a specific tree ID has issued an attribute acquisition request in step S1007 in FIG. 10, in the reversion/proxy response information management unit 303. This attribute information includes a resource name, a resource size, access date and time, updated date and time, and creation date and time. Those pieces of management information and connection management information are passed to the sub control unit 210 in accordance with the procedure shown in FIG. 7, and thereby the reversion/proxy response function of the sub control unit 210 at the time of transition into the power saving state is achieved.

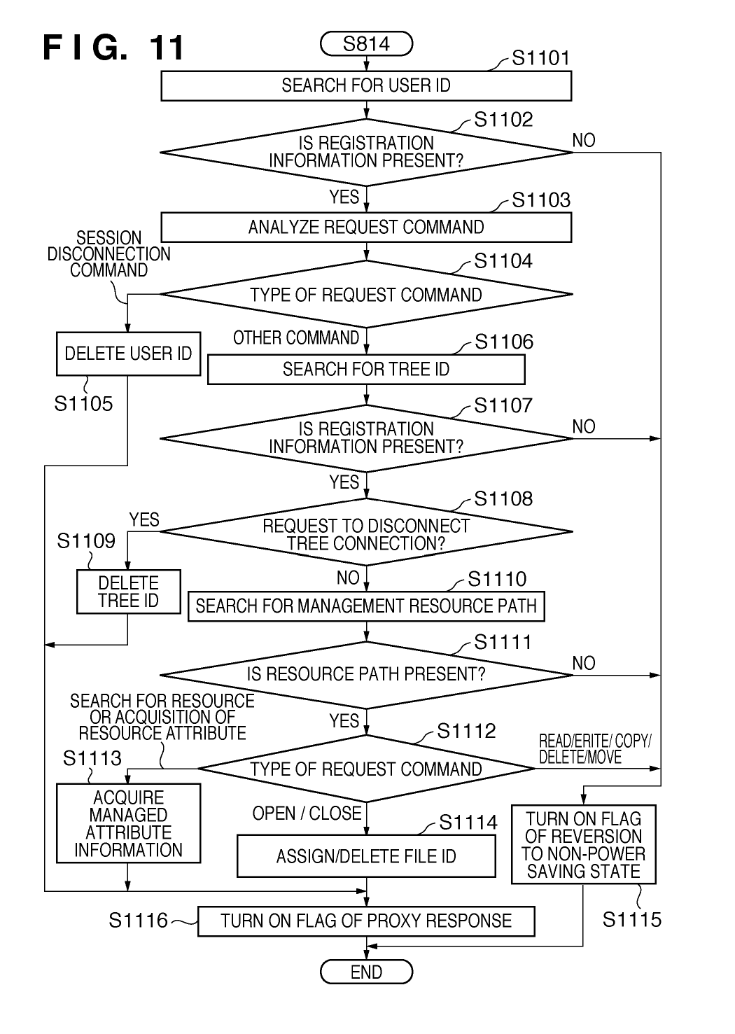

FIG. 11 is a flowchart illustrating processing performed by the sub control unit 210 in the power saving state according to the second embodiment. This processing is performed under control of the Sub CPU 211 in accordance with a program stored in the ROM 212. The case where the SMB/CIFS protocol is applied to the above-described step S814 in FIG. 8B will be described with reference to FIG. 11.

First, in step S1101, the reversion/proxy response determination unit 313 in the sub control unit 210 acquires a user ID from the received SMB/CIFS data and searches for the same user ID from SMB/CIFS data stored in the reversion/proxy response information holding unit 312. Then, it is determined in step S1102 whether or not the user ID is present in the reversion/proxy response information holding unit 312, and if the user ID is not present, the reversion/proxy response determination unit 313 determines that the client has requested to establish a new SMB/CIFS connection, and therefore the procedure proceeds to step S1115, that is, the process of reversion to the non-power saving state. On the other hand, if the user ID is present in the reversion/proxy response information holding unit 312 in step S1102, the procedure proceeds to step S1103, in which the reversion/proxy response determination unit 313 analyzes a command requested by the client in the received SMB/CIFS data. The procedure then proceeds to step S1104, in which it is determined whether or not the request command is a request to disconnect an SMB/CIFS session. If the request command is an SMB/CIFS session disconnection request, the procedure proceeds to step S1105, in which the reversion/proxy response determination unit 313 deletes the user ID and related information in the reversion/proxy response information holding unit 312, and thereafter the procedure proceeds to step S1116. The related information as used herein refers to all SMB/CIFS data related to the user ID.

On the other hand, if the request command is not an SMB/CIFS session disconnection request in step S1104, the procedure proceeds to step S1106. In step S1106, the reversion/proxy response determination unit 313 acquires a tree ID from the received data. The procedure then proceeds to step S1107, in which the reversion/proxy response determination unit 313 searches for the same tree ID as the acquired tree ID from data related to the user ID held in the reversion/proxy response information holding unit 312. If the tree ID being searched for is not present, the reversion/proxy response determination unit 313 determines that this is a client's request to connect to a new resource tree, and thereafter the procedure proceeds to step S1115 and shifts to the process of reversion to the non-power saving state.

On the other hand, if the tree ID being searched for is present in step S1107, the procedure proceeds to step S1108, in which the reversion/proxy response determination unit 313 determines the type of the request command that was analyzed in step S1103. In step S1108, if the request command is a request to disconnect a tree connection, the procedure proceeds to step S1109, in which the reversion/proxy response determination unit 313 deletes the tree ID and related resource information held in the reversion/proxy response information holding unit 312, and thereafter the procedure proceeds to step S1116. The related resource information as used herein refers to all resource path information and attribute information existing under the shared resource corresponding to the tree ID.

On the other hand, if the request command is not a tree connection disconnection request in step S1108, the procedure proceeds to step S1110, in which the reversion/proxy response determination unit 313 acquires a resource path targeted for processing from the received data. The reversion/proxy response determination unit 313 then searches for the same resource path as the acquired resource path from data related to the user ID and the tree ID held in the reversion/proxy response information holding unit 312. Then, it is determined in step S1111 whether or not the resource path being searched for is present. If the resource path is not present, the reversion/proxy response determination unit 313 determines that the client has requested to connect to a new resource path, and thereafter the procedure proceeds to step S1115 and shifts to the process of reversion to the non-power saving state. In the second embodiment, although the procedure shifts to the process of reversion to the non-power saving state in step S1115, it is also possible, depending on specifications of proxy response processing, to determine that the resource path is not present and give an error proxy response indicating that fact.

On the other hand, if the resource path being searched for is present in step S1111, the procedure proceeds to step S1112, in which the reversion/proxy response determination unit 313 determines the type of the request command that was analyzed in step S1103. Here, if the request command has been determined as a file control request for the resource path searched for, it becomes necessary to perform control processing on an entity file stored in the HDD 206 in the image forming apparatus 101.

In the second embodiment, because the HDD 206 in the image forming apparatus 101 is in the sleep mode in the power saving state and no power is passed in the power saving state, the image forming apparatus needs to revert to the non-power saving state if control processing needs to be performed on an entity file. Accordingly, in this case, the procedure proceeds from step S1112 to step S1115, and the reversion/proxy response determination unit 313 shifts to the process of reversion to the non-power saving state. The file control request determined in step S1112 refers to processing such as reading a file, writing to a file, duplicating a file, moving a file, and deleting a file. On the other hand, if the request command has been determined as a request to search for a resource or a request to acquire the resource attribute in step S1112, the procedure proceeds to step S1113. In step S1113, the reversion/proxy response determination unit 313 acquires resource attribute information under management of the reversion/proxy response information holding unit 312. The procedure then proceeds to step S1116. If the request command has been determined as a request to close a resource in step S1112, the procedure proceeds to step S1114. In step S1114, the reversion/proxy response determination unit 313 deletes a resource file ID managed by the reversion/proxy response information holding unit 312. When the image forming apparatus 101 has reverted to the non-power saving state, the application protocol control unit 307 in the Main CPU 201 is notified of all information managed by the reversion/proxy response information holding unit 312. This allows the application protocol control unit 307 to recognize that the resource corresponding to the file ID has been closed and perform subsequent control processing related to a targeted resource. If the request command has been determined as a request to open a resource in step S1112, the procedure proceeds to step S1114. In step S1114, the reversion/proxy response determination unit 313 assigns a new file ID to a corresponding resource managed by the reversion/proxy response information holding unit 312. When the image forming apparatus 101 has reverted to the non-power saving state, the application protocol control unit 307 in the Main CPU 201 is notified of all information managed by the reversion/proxy response information holding unit 312. This allows the application protocol control unit 307 to recognize that the resource corresponding to the file ID has been opened and perform subsequent control processing related to the targeted resource. In step S1116, the reversion/proxy response determination unit 313 does not perform the process of reversion to the non-power saving state, and shifts to the process for giving a proxy response under control of the Sub CPU 211.

According to the second embodiment as described above, it is possible to revert to the non-power saving state or to create a response packet and give a proxy response in accordance with the contents of a protocol packet received in the power saving state.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a storage medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-291404, filed Dec. 22, 2009, which is hereby incorporated by reference herein in its entirety.

1. An image forming apparatus comprising a main control unit that operates in at least a first power state or a second power state with lower power consumption than the first power state, and a sub control unit that performs communication with an information processing apparatus via a network when the main control unit is in the second power state,
the image forming apparatus comprising:
a sleep control unit configured to cause the main control unit to transition into the second power state and to notify the sub control unit of communication connection information that is updated in accordance with execution of communication via the network, so as to cause the sub control unit to hold the communication connection information;
a determination unit configured to, upon reception of data from the information processing apparatus when the main control unit is in the second power state, determine, based on the received data, whether to cause the main control unit to revert to the first power state or to cause the sub control unit to make a response to the received data without the main control unit reverting to the first power state;
a response unit configured to, when the determination unit has determined that the sub control unit is to make a response to the received data without the main control unit reverting to the first power state, generate response information for the received data, transmit the response information to the information processing apparatus, and update the communication connection information held in the sub control unit; and
a reversion unit configured to, when the determination unit has determined to cause the main control unit to revert to the first power state, cause the main control unit to revert to the first power state and notify the main control unit of the communication connection information held by the sub control unit.

2. The image forming apparatus according to claim 1, wherein the communication connection information includes a value that is updated in accordance with execution of communication via the network and a fixed value that is not updated in accordance with execution of communication via the network.

3. The image forming apparatus according to claim 1, wherein the response unit generates the response information, using packet pattern information that is set by an application controlled by the main control unit.

4. The image forming apparatus according to claim 1, further comprising:
a detection unit configured to detecting a problem in the received data,
wherein, when the detection unit has detected a problem in the received data, the received data is discarded without the main control unit reverting to the first power state and the response information being transmitted.

5. The image forming apparatus according to claim 1, wherein the communication connection information includes information regarding a TCP protocol.

6. The image forming apparatus according to claim 1, wherein the communication connection information includes information regarding an SMB protocol or a CIFS protocol.

7. A control method for an image forming apparatus comprising a main control unit that operates in at least a first power state or a second power state with lower power consumption than the first power state, and a sub control unit that performs communication with an information processing apparatus via a network,
the control method comprising:
a sleep control step of causing the main control unit to transition into the second power state and to notify the sub control unit of communication connection information that is updated in accordance with execution of communication via the network, so as to cause the sub control unit to hold the communication connection information;
a determination step of, upon reception of data from the information processing apparatus when the main control unit is in the second power state, determining, based on the received data, whether to cause the main control unit to revert to the first power state or to cause the sub control unit to make a response to the received data without the main control unit reverting to the first power state;
a response step of, when it has been determined in the determination step that the sub control unit is to make a response to the received data without the main control unit reverting to the first power state, generating response information for the received data, transmitting the response information to the information processing apparatus, and updating the communication connection information held in the sub control unit; and
a reversion step of, when it has been determined in the determination step to cause the main control unit to revert to the first power state, causing the main control unit to revert to the first power state and notifying the main control unit of the communication connection information held in the sub control unit.

8. A non-transitory computer-readable storage medium storing a program to be executed by a computer comprising a main control unit that operates in at least a first power state or a second power state with lower power consumption than the first power state, and a sub control unit that performs communication with an information processing apparatus via a network, the program causing the computer to perform the steps of:
causing the main control unit to transition into the second power state and to notify the sub control unit of communication connection information that is updated in accordance with execution of communication via the network, so as to cause the sub control unit to hold the communication connection information;
upon reception of data from the information processing apparatus when the main control unit is in the second power state, determining, based on the received data, whether to cause the main control unit to revert to the first power state or to cause the sub control unit to make a response to the received data without the main control unit reverting to the first power state;
when it has been determined in the determination step that the sub control unit is to make a response to the received data without the main control unit reverting to the first power state, generating response information for the received data, transmitting the response information to the information processing apparatus, and updating the communication connection information held in the sub control unit; and
when it has been determined to cause the main control unit to revert to the first power state, causing the main control unit to revert to the first power state and notifying the main control unit of the communication connection information held by the sub control unit.
